(19) United States
(12) Patent Application Publication
(10) Pub. No.: US 2023/0412423 A1
(43) Pub. Date: Dec. 21, 2023

(54) DEVICES AND SYSTEMS THAT CONNECT IIOT EDGE DEVICES AND APPLICATIONS TO A CORPORATE DATA NETWORK

(71) Applicant: Schlumberger Technology Corporation, Sugar Land, TX (US)

(72) Inventors: Maria Krovatkina, Houston, TX (US); Jan Stefan Morley, Sugar Land, TX (US)

(21) Appl. No.: 18/248,070

(22) PCT Filed: Oct. 5, 2021
(86) PCT No.: PCT/US2021/071729

§ 371 Date: Apr. 6, 2023

Related U.S. Application Data
(60) Provisional application No. 63/089,855, filed on Oct. 9, 2020.

(51) Int. Cl. H04L 12/46; H04L 12/66

(52) U.S. Cl. CPC H04L 12/4641; H04L 12/66

(57) ABSTRACT

A gateway device suitable for Industrial Internet of Things (IIoT) applications provides data communication to a corporate data network via at least one wide area network (WAN). The device includes at least one northbound data communication interface operably coupled to the at least one WAN, at least one southbound data communication interface operably coupled to at least one local area network (LAN), a data plane operably coupled to the at least one northbound data communication interface and the at least one southbound data communication interface, and an SD-WAN controller implemented by at least one software module that executes on at least one processor of the gateway device.

### CROSS-REFERENCE TO RELATED APPLICATION(S)

The present application claims priority from U.S. Provisional Appl. No. 63/089,855, filed on Oct. 9, 2020, herein incorporated by reference in it is entirety.

### BACKGROUND

The subject disclosure relates to the fields of data communication networks and distributed computing platforms.

Wide Area Networks (WANs), such as the Internet, MPLS networks, and cellular data networks, provide data communication over large distances. For example, in enterprise environments, one or more WANs can provide for data communication between device(s) connected to a remote local area network (or branch network) and one or more central corporate data centers or other centralized corporate network resources. The WAN(s) can also support data communication between such device(s) and one or more cloud service providers.

In traditional implementations, the data communication between such device(s) and the centralized corporate network resources as well as the data communication between such device(s) and the cloud service providers are configured to flow through one or more virtual secure tunnels (e.g., VPN tunnels) that extend across one or more WAN(s) and thus couples the remote local area network to the corporate network.

Software-defined WANs (SD-WANs) are virtual networks that are overlaid on one or more WANs and thus are defined separately from the underlying physical WANs. The topology, security, and forwarding rules for data communication over an SD-WAN can be specified independently for the SD-WAN. This design allows for scalable secure segmentation of data traffic carried on the SD-WAN for different applications and services.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In accordance with aspects herein, a gateway device is provided that is suitable for Industrial Internet of Things (IIoT) applications. The gateway device provides data communication to a corporate data network via at least one wide area network (WAN). The gateway device includes at least one northbound data communication interface operably coupled to the at least one WAN, at least one southbound data communication interface operably coupled to at least one local area network (LAN), a data plane operably coupled to the at least one northbound data communication interface and the at least one southbound data communication interface, and an SD-WAN controller implemented by at least one software module that executes on at least one processor of the gateway device. In embodiments, the SD-WAN controller configures and controls the operation of the data plane to implement at least one software-defined wide area network (SD-WAN) overlaid on the at least one WAN. In this manner, the SD-WAN controller configures the data plane to intelligently forward data between the at least one LAN and the corporate data network over the at least one SD-WAN.

In embodiments, the operations of the SD-WAN controller in configuring the data plane can be programmed and controlled by a centralized control plane server/cluster, for example, using programming instructions designed or optimized for the data-plane. The SD-WAN controller can be implemented by software that executes on at least one processor of the gateway device. The software can be configured to receive such instructions and configure the data plane automatically in accordance with the received instructions. The operations of the SD-WAN controller can enable efficient implementation of the SD-WAN on the gateway device, while avoiding requiring a user to understand and configure complex networking functionality, such as firewall rules, routing rules and logic, and check monitoring, on the gateway device.

The gateway device can further include at least one application module implemented by software that executes on at least one processor of the gateway device. The SD-WAN controller can configure the data plane to intelligently forward application data between the application module(s) and the corporate data network over the at least one SD-WAN.

In embodiments, the at least one northbound data communication interface can include at least one data communication interface supporting a wired WAN connection for communication to the corporate data network. For example, the wired WAN connection can be an Ethernet connection.

In embodiments, the at least one northbound data communication interface can include at least one data communication interface supporting a wireless WAN connection for communication to the corporate data network. For example, the wireless WAN connection can be a cellular data connection or a satellite data connection.

In embodiments, the at least one southbound data communication interface can include at least one data communication interface supporting a wired LAN connection for communication to the at least one LAN. For example, the wired LAN connection can be an Ethernet connection.

In embodiments, the at least one southbound data communication interface can include at least one data communication interface supporting a wireless LAN connection for communication to the at least one LAN. For example, the wireless LAN connection can be a Wi-Fi connection.

In embodiments, the SD-WAN controller and possibly at least one application module executing on the gateway device can be implemented by software containers.

In embodiments, the at least one SD-WAN can provide a secure connection to the corporate data network.

In embodiments, the at least one SD-WAN can further provide a secure connection to a cloud computing environment.

In embodiments, the SD-WAN controller can configure the data plane to intelligently forward outbound data to the at least one WAN of the SD-WAN according to pre-defined rules.

In embodiments, the SD-WAN controller can configure the data plane to adapt forwarding of outbound data to the at least one WAN of the SD-WAN under changing network conditions.

In embodiments, the SD-WAN controller and the data plane can be configured to provide additional functionality selected from the group consisting of: i) network address translation or proxying services; ii) firewall services; iii) a network segmentation function that defines virtual LANs for at least one LAN; and iv) support one or more zero-trust policies, which involves authenticating and authorizing access and communication to devices and applications associated with the at least one LAN, including the at least one application module.

In embodiments, the SD-WAN controller can control the data plane to automatically perform switchover between different WAN links of the least one SD-WAN based on network conditions related to the different WAN links.

In embodiments, the SD-WAN controller can control the data plane to automatically perform switchover between different WAN links of SD-WANs defined by a plurality of gateway devices. The plurality of gateway devices can be operably coupled to the at least one LAN, or directly connected to one another.

In embodiments, the SD-WAN controller and data plane can be configured to manage network redundancy for at least one local device connected to the gateway device or manage network redundancy for at least one local device connected to a plurality of gateway devices.

### BRIEF DESCRIPTION OF DRAWINGS

The subject disclosure is further described in the detailed description which follows, in reference to the noted plurality of drawings by way of non-limiting examples of the subject disclosure, in which like reference numerals represent similar parts throughout the several views of the drawings, and wherein:

FIG. 1 is a schematic illustration of a gateway device suitable for IIoT applications, which connects industrial control systems (ICS) to a cloud computing environment as well as to a corporate data center or network;

FIG. 2 is a schematic diagram of a gateway device suitable for IIoT applications that defines a software-defined WAN (SD-WAN) overlay on one or more WANs in accordance with the present disclosure;

FIG. 3 is a schematic diagram illustrating different configurations and functionality of the gateway device of FIG. 2 in accordance with the present disclosure;

FIG. 4 is a schematic diagram illustrating the gateway device of FIG. 2 connected to a corporate data network in accordance with the present disclosure;

FIGS. 5A and 5B are schematic diagrams illustrating the configuration of multiple gateway devices to provide automatic WAN switchover functionality and other network redundancy functions in accordance with the present disclosure; and

FIG. 6 is a schematic diagram of a computer system.

### DETAILED DESCRIPTION

The particulars shown herein are by way of example and for purposes of illustrative discussion of the embodiments of the subject disclosure only and are presented in the cause of providing what is believed to be the most useful and readily understood description of the principles and conceptual aspects of the subject disclosure. In this regard, no attempt is made to show structural details in more detail than is necessary for the fundamental understanding of the subject disclosure, the description taken with the drawings making apparent to those skilled in the art how the several forms of the subject disclosure may be embodied in practice. Furthermore, like reference numbers and designations in the various drawings indicate like elements.

In Industrial Internet of Things (IIoT) applications and environments, a distributed computing platform can be used for operational surveillance, diagnostics, optimization, and management of physical industrial assets that are located remotely from both a corporate data network and from one or more cloud computing environments. For example, in oilfield applications, the distributed computing platform can be configured to interface to a variety of sensor and control instrumentation used in oilfield equipment (such as pumps, valves, actuators, etc.) at a remote well site or facility and implement various communication protocols to connect such sensor and control instrumentation to the corporate data network and/or the cloud computing environment(s) to provide for monitoring, diagnostics, control and management of the oilfield equipment.

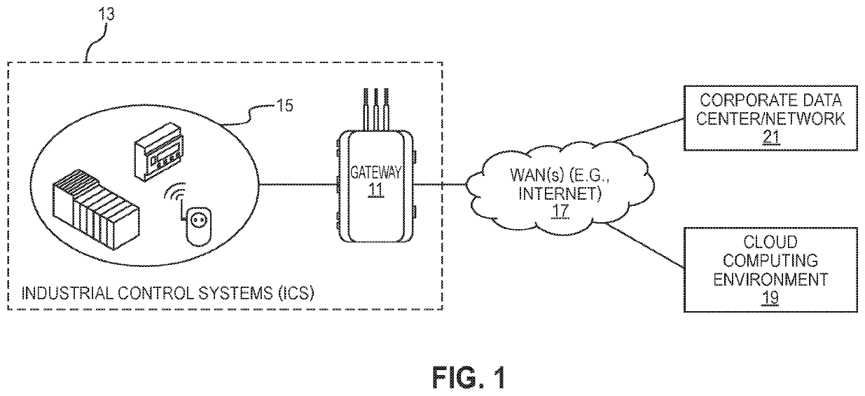

In embodiments, the distributed computing platform can embody a gateway device 11 that resides at an industrial facility 13 (FIG. 1). The gateway device 11 is operably coupled (or interfaces) to one or more systems 15 (e.g., industrial control systems) located at the industrial facility 13. For example, gateway device 11 can be configured with one or more bi-directional communication interfaces to the one or more systems 15 using a wired communication protocol (such as a serial, Ethernet, Modbus, or Open Platform Communication (OPC) protocol) and/or a wireless communication protocol (such as IEEE 802.11 Wi-Fi protocol, Highway Addressable Remote Transducer Protocol (HART), LoraWAN, or Message Queuing Telemetry Transport (MQTT)). The gateway device 11 can be configured with one or more bi-directional communication interfaces to one or more WANs 17. For example, the gateway device 11 can be configured with a bi-directional wired communication interface to an Ethernet-based WAN 17. Additionally or alternatively, the gateway device 11 can be configured with a bi-directional wireless communication interface to a Wi-Fi-based WAN 17. Additionally or alternatively, the gateway device 11 can be configured with a bi-directional wireless communication interface to a cellular WAN 17. Additionally or alternatively, the gateway device 11 (or an external device) can provide a bi-directional wireless satellite link to a satellite-based WAN 17 (such as BGAN). The WAN(s) 17 can include one or more private WANs and/or the public Internet. The WAN(s) 17 can support broadband connections, such as digital subscriber lines (DSL), and DOCSIS cable modems, and cellular wireless access connections such as LTE and 5G. The WAN(s) 17 can also support other connections, such as MPLS lines, T1 and T3 lines, OC3 lines, OC48 lines, and fiber-optic connections. The WAN(s) 17 typically employ one or more routing protocols to facilitate the efficient routing of data packets over the WAN(s) 17. Non-limiting examples of such routing protocols include Border Gateway Protocol (BGP), Routing Information Protocol (RIP), Interior Gateway Routing Protocol (IGRP), Enhanced IGRP (EIGRP), and Open Shortest Path First (OSPF). The WAN(s) 17 can provide for data communication between the gateway device 11 and one or more cloud computing environment(s) 19. The WAN(s) 17 can also provide for data communication between the gateway device 11 and one or more corporate data centers or networks 21.

The gateway device 11 can be configured to deliver performance edge computing and/or secure data ingestion. For example, the edge computing and/or data ingestion can support or enable real-time monitoring and control of the system(s) 15 at facility 13. Computer systems that belong to the corporate data network 21 and/or the cloud computing environment(s) 19 can be used to securely provision, configure and manage the gateway device 11 over its operational lifetime.

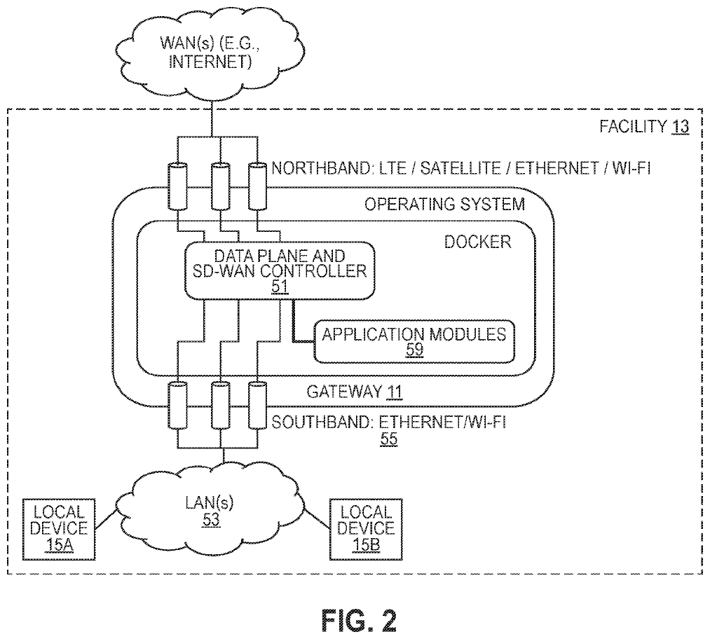

Maintaining secure and reliable connectivity to facility 13 is important for IIoT applications and environments. To provide these features, the gateway device 11 is configured to provide a data plane (or forwarding plane) and an SD-WAN controller, collectively labeled as part 51 in FIG. 2. The data plane of part 51 is operably coupled to one or more local area networks (LAN(s)) 53 at facility 13 via one or more southbound communication interface(s) 55. The southbound communication interface(s) 55 can provide bi-directional communication to the LAN(s) 53 using a wired communication protocol (such as Ethernet) and/or a wireless communication protocol (such as one or more IEEE 802.11 Wi-Fi protocols). In embodiments, the southbound communication interface(s) 55 can include an Ethernet controller (i.e., MAC & PHY components) embodied by system-on-chip functionality or other integrated circuit functionality. The southbound communication interface(s) 55 can also include a Wi-Fi transceiver embodied by system-on-chip functionality or other integrated circuit functionality. Additionally or alternatively, one or more components of the southbound communication interface(s) 55 can be embodied by a separate unit external to the gateway device 11. One or more local devices (e.g., two labeled 15A, 15B) that are located at facility 13 are operably coupled to the LAN(s) 53 for communication to the gateway device 11 via the LAN(s) 53 and the southbound communication interface(s) 55 of the gateway device 11. The local devices (e.g., 15A, 15B) can include edge devices, such as smart sensors, computer-based systems, industrial control systems, or other networked devices and systems. The data plane of part 51 is also operably coupled to one or more WAN(s) 17 via one or more northbound communication interface(s) 57. In embodiments, the northbound communication interface(s) 57 can provide a bi-directional wired communication interface to an Ethernet-based WAN. In embodiments, the northbound communication interface(s) 57 can include an Ethernet controller (i.e., MAC & PHY components) embodied by system-on-chip functionality or other integrated circuit functionality. Additionally or alternatively, the northbound communication interface(s) 57 can provide a bi-directional wireless communication interface to a Wi-Fi based WAN. In embodiments, the northbound communication interface(s) 57 can include a Wi-Fi transceiver embodied by system-on-chip functionality or other integrated circuit functionality. Additionally or alternatively, the northbound communication interface(s) 57 can provide a bi-directional wireless communication interface to a cellular WAN. In embodiments, the northbound communication interface(s) 57 can include a cellular WAN transceiver embodied by system-on-chip functionality or other integrated circuit functionality. Additionally or alternatively, the northbound communication interface(s) 57 can provide a bi-directional wireless satellite link to a satellite-based WAN. In embodiments, the northbound communication interface(s) 57 can include a satellite WAN transceiver embodied by integrated circuit functionality. Additionally or alternatively, one or more components of the northbound communication interface(s) 57, such as the bi-directional wireless satellite link, can be embodied by a separate unit external to the gateway device 11. The cloud computing environment 19 and the corporate data center/network 21 that are remotely located from facility 13 are operably coupled to the WAN(s) 17 for communication to the gateway device 11 via the WAN(s) 17 and the northbound communication interface(s) 57 of the gateway device 11.

The SD-WAN controller of part 51 configures and controls the operation of the data plane of part 51 to implement at least one software-defined wide area network (SD-WAN) overlaid on the WAN(s) 17. In this manner, the SD-WAN controller configures the data plane to intelligently forward data between the LAN(s) 53 and the cloud computing environment 19 and the corporate data center/network 21 over the at least one SD-WAN.

In embodiments, the operations of the SD-WAN controller in configuring the data plane can be programmed and controlled by a centralized control plane server/cluster, for example, using programming instructions designed or optimized for the data-plane. The SD-WAN controller can be implemented by software that executes on at least one processor of the gateway device. The software can be configured to receive such instructions and configure the data plane automatically in accordance with the received instructions.

In embodiments, the SD-WAN controller can coordinate with the centralized control plane server/cluster (not shown) to define the one or more SD-WANs that are overlaid on the WAN(s) 17. For example, the SD-WAN controller plane can advertise routes and services that it has learned from its directly connected networks from traditional routing protocols, such as OSPF and BGP. Such routing information provides reachability to the directly connected networks. The importing of routing information from the traditional routing protocols can be subject to user-defined policies. From a logical point of view, the environment consists of a centralized controller and one or more edge devices (gateway devices with SD-WAN controllers) where each edge device advertises its imported routes to the centralized controller and based on policy decisions, this centralized controller distributes the overlay routing information to the edge device(s). The SD-WAN controller at the edge device can use the overlay routing information to construct and/or deliver a forwarding table for the data plane of part 51. The operations of the SD-WAN controller can enable efficient implementation of the SD-WAN on the gateway device, while avoiding requiring a user to understand and configure complex networking functionality, such as firewall rules, routing rules and logic, and check monitoring, on the gateway device.

The SD-WAN controller configures the data plane of part 51 to securely and intelligently forward data (including packet data received from the local devices of the facility 13 via the LAN(s) 53 as well as data generated by the application module(s) 59 executing on the gateway device 11) over the one or more SD-WANs to the appropriate destination. In embodiments, the forwarding of such data can employ a forwarding table that is constructed according to the overlay routing information that defines the one or more SD-WANs that are overlaid on the WAN(s) 17. The destination for such data can be the cloud computing environment 19, the corporate data center/network 21, or some other system or device remotely located from facility 13 and operably coupled to the WAN(s) 17. The data plane of part 51 can also be configured to forward inbound packet data (which is received from WAN(s) 17) to the appropriate destination. The destination for such data can be the application module(s) 59 executing on gateway device 11, or the LAN(s) 53 for communication to a local device of the facility 13.

In embodiments, the SD-WAN controller of part 51 can be implemented as one or more software modules (e.g., software-based middleware) that executes on the gateway device 11. In embodiments, the SD-WAN controller of part 51 and one or more application modules 59 that executes on gateway device 11 can be implemented as software containers. A software container is a standard unit of software that packages up code and all its dependencies (such as runtime environment, system tools, system libraries, and settings) so that the software runs quickly and reliably in the computing environment of the gateway device 11. The software container isolates software from its environment and ensures that it works uniformly and reliably in the computing environment. The software containers can be configured to communicate with one another through well-defined channels. In one non-limiting example, the software containers can be implemented via Docker technology available from Docker, Inc. of Palo Alto, CA. The application module(s) 59 can be configured to provide a range of functionality, such as provisioning and managing the gateway device 11 under control from a remote system, control of the industrial assets at the facility 13 (e.g., the local devices 15A, 15B), aggregation of data (for example, data supplied by the local devices 15A, 15B), edge computing, machine learning and artificial intelligence. Such functionality can be used for operational surveillance, diagnostics, optimization, control, management, and other functions related to the industrial assets of the facility 13. The gateway device 11 can include other software-based middleware that enables the deployment and remote management of the application module(s) 59 that execute on gateway device 11 and other security features of gateway device 11. For example, the software-based middleware can provide security services including TPM-based authentication of the application module(s) 59 and authorized local access through a local user interface. Such software-based middleware can also be implemented as software containers, if desired.

In embodiments, the data plane of part 51 of the gateway device 11 can be implemented by data packet forwarding circuitry embodied by one or more integrated circuits or application-specific integrated circuits (ASICs). Such data packet forwarding circuitry can possibly be part of a system-on-chip (SOC) design that combines the data packet forwarding functionality with the functionality of the southbound communication interface(s) 55 (or part(s) thereof) and/or the northbound communication interfaces 57 (or part(s) thereof). Alternatively, the data plane of part 51 of the gateway device 11 can be implemented by software that executes on gateway device 11 or a mix of software and hardware. Such data plane software can be implemented as software containers, if desired. Furthermore, such data plane software can be executed on the same processor(s) that execute the SD-WAN controller, or by one or more different processor(s).

In embodiments, the SD-WAN controller can configure the data plane of part 51 to intelligently forward outbound data to the WAN(s) 17 according to pre-defined rules, usually programmed via templates. The SD-WAN controller can also adapt such forwarding under changing network conditions, such as when congestion or impairment occurs, through monitoring of such conditions. In this manner, the SD-WAN controller can configure and control the data plane of part 51 to implement one or more SD-WANs that are overlaid on the WAN(s) 17.

The functionality of the SD-WAN controller and the data plane of part 51 can also provide other useful networking functions, such as network address translation or proxying which involves modifying network address information in the IP header of data packets received from the LAN(s) 53 (or in the IP header of data packets carrying data generated by the application module(s) executing on gateway device 11) for communication over the one or more SD-WANs, and firewall services that monitors packet data received from the SD-WAN(s) or LAN(s) 53 to decide whether to allow or block specific packet data from transport through the SD-WAN interface 51. Such filtering decisions can be based on a defined set of security rules, stateful inspection of state, port, and protocol, and possibly other advanced processing. In embodiments, such advanced networking functionality can be configured by the central controller and distributed to the SD-WAN controller implemented on the gateway device.

In embodiments, the functionality of the SD-WAN controller and the data plane of part 51 can also be configured to provide a network segmentation function, which involves specifying segments in the LAN(s) 53 that are defined by virtual LANs (VLANs). The VLANs create smaller network segments (e.g., subnets) with all local machines or nodes on a VLAN connected virtually to each other as if they were in the same network. Support for LANs can be provided by configuring data frame forwarding circuitry or software logic implemented by the data plane of part 51 to create the appearance and functionality of network traffic on the LAN(s) 53 that is split between the separate network segments despite such segments being connected to the same physical network. For example, a VLAN can be used to separate traffic based on QOS parameters characteristics (e.g. low-priority traffic prevented from impinging on high-priority traffic) or based on security measures. In embodiments, such network segmentation functionality can be configured by the central controller and distributed to the SD-WAN controller implemented on the gateway device.

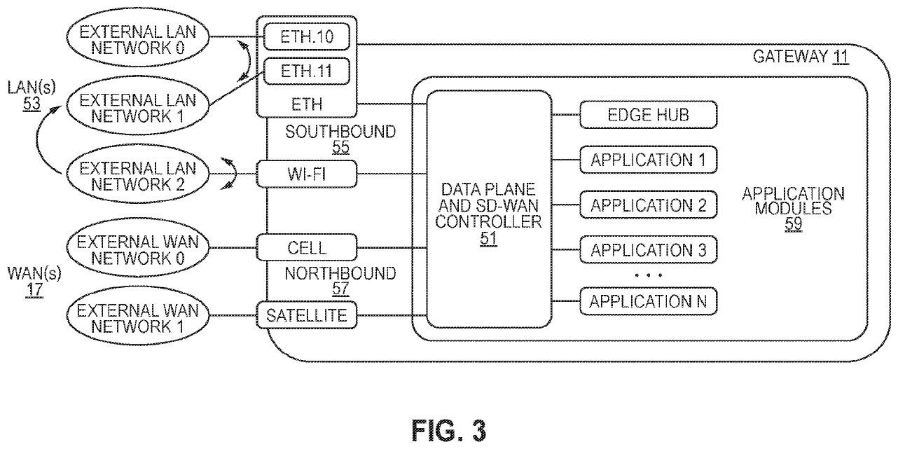

In an illustrative configuration shown in FIG. 3, the functionality of the SD-WAN controller and the data plane of part 51 is configured to provide network segmentation that supports two VLANs (labeled “eth.10” or “LAN network 0”, and “eth.11” or “LAN network 1”) that connect to the data plane of part 51 via the southbound communication interface(s) 55 of the gateway device 11. The data plane of part 51 also connects to a wireless LAN (labeled “LAN network 2”) via the southbound communication interface(s) 55 of the gateway device 11. The data plane of part 51 also connects to a cellular WAN (labeled “WAN network 0”) via the northbound communication interface(s) 57 of the gateway device 11. The data plane of part 51 also connects to a satellite-based WAN (labeled “WAN network 1”) via the northbound communication interface(s) 57 of the gateway device 11. The SD-WAN controller controls the data plane of part 51 to manage the flow of packet data between the various LAN(s) 53, including forwarding packet data between the local devices connected to the LAN(s) 53 and essentially acting like a network switch.

The functionality of the SD-WAN controller and the data plane of part 51 can also be configured to support one or more zero-trust policies, which involves authenticating and authorizing access and communication to devices and applications associated with the LAN(s) 53, including the applications embodied by the application module(s) 59 executing on the gateway device 11. Such zero-trust policies can be configured to provide for granular control over the communication between devices, users, and applications.

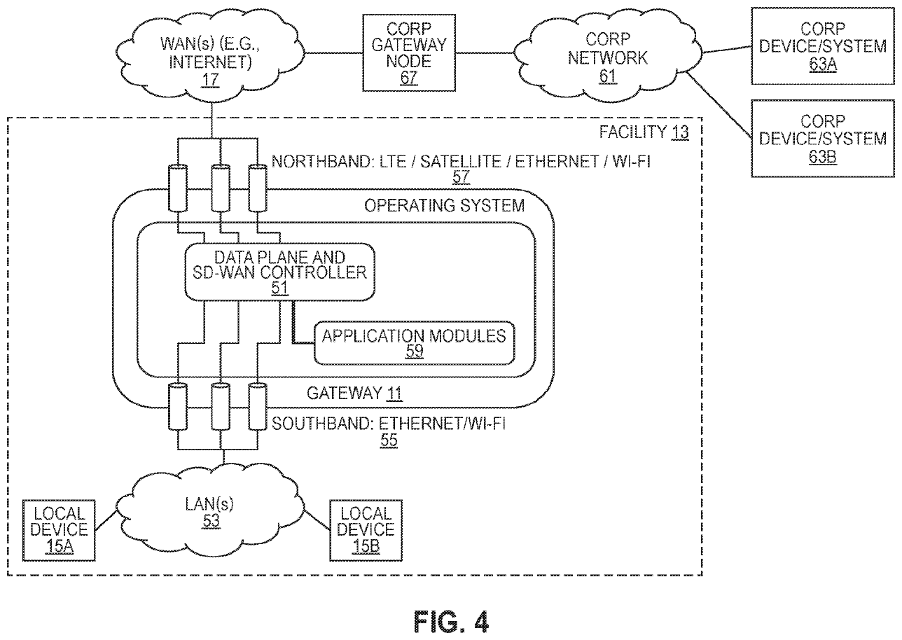

FIG. 4 depicts an example system where the gateway device 11 is configured to provide for data communication to a corporate network 61 through an SD-WAN that is overlaid on the WAN(s) 17. In this example system, the SD-WAN controller controls the data plane of part 51 of the gateway device 11 to implement a network segmentation function and zero-trust policies as described herein to permit local devices at facility 13 (e.g., local devices 15A or 15B) to securely connect to the corporate network 61 and the corporate network systems/devices connected thereto (e.g., 63A, 63B). In this configuration, the data packet traffic to and from the local devices at facility 13 (e.g., local devices 15A or 15B) can be completely isolated from the data traffic to and from applications or middleware executing on the gateway device 11. In this manner, the function of the SD-WAN controller and the data plane of part 51 of the gateway device 11 can create two isolated zones at facility 13: one zone for the IIoT applications and middleware, and the other zone for corporate applications.

In embodiments, a corporate gateway node 67 is coupled between the WAN(s) 17 and the corporate network 61 (e.g., at the border of the corporate network) and configured to manage the data communication between the corporate network 61 and the gateway device 11 over the SD-WAN that is overlaid on the WAN(s) 17. In embodiments, the corporate gateway node 67 can be located in a corporate data center or a cloud computing environment. The corporate gateway node 67 can serve multiple purposes, such as permitting secure communication between the corporate network and the remote gateway device 11. This can improve security and allows for the gateway device 11 to connect to devices both inside and outside the corporate network 61.

In embodiments, there can be different options for gateway device 11 to connect to the corporate network 61 depending on the location of the corporate gateway node 67. For example, if the corporate gateway node 67 is in a corporate data center, the isolated data traffic from the gateway device 11 can be directed to the corporate gateway node 67 and associated firewall. In another example, data traffic tunneling or smart network address translation can be used to communicate the data traffic from the gateway device 11 and through the corporate gateway node 67 and associated firewalls to another data center or secure enclave, where the data traffic can open up to another set of firewalls. In yet another example, the corporate gateway node 67 can be located in a public or hybrid cloud it can land data traffic on cloud firewalls, which will allow to forward it to corporate cloud resources, or through various peering options (e.g., if available on hybrid cloud) to the corporate network.

The data traffic that is communicated between gateway device 11 and corporate gateway node 67 can be secured by encryption. For example, end-to-end application-layer encryption can be used to secure such data traffic. Alternatively, or additionally, the SD-WAN controller and the data plane of part 51 of the gateway device 11 as well as the corporate gateway node 67 can support encryption and decryption of data traffic communicated therebetween which is separate from application-layer encryption.

The corporate gateway node 67 can also be configured to assist the remote gateway device 11 (and possibly multiple remote gateway devices 11) in automatically and seamlessly connecting to the corporate network devices and systems (e.g., 63A, 63B). In this manner, the corporate gateway node 67 can help to create an abstraction, where a number of remote gateway devices 11 can communicate with each other and with corporate network 61 without detailed knowledge of the underlying physical WAN network(s) that connect them.

The SD-WAN controller and the data plane of part 51 of the gateway device 11 can also be configured to track WAN connection performance to make WAN switchover decisions based on packet loss, latency, etc. Specifically, the SD-WAN controller can control the data plane of part 51 of the gateway device 11 to automatically perform sub-second switch-over between different WAN links based on network conditions related to the different WAN links.

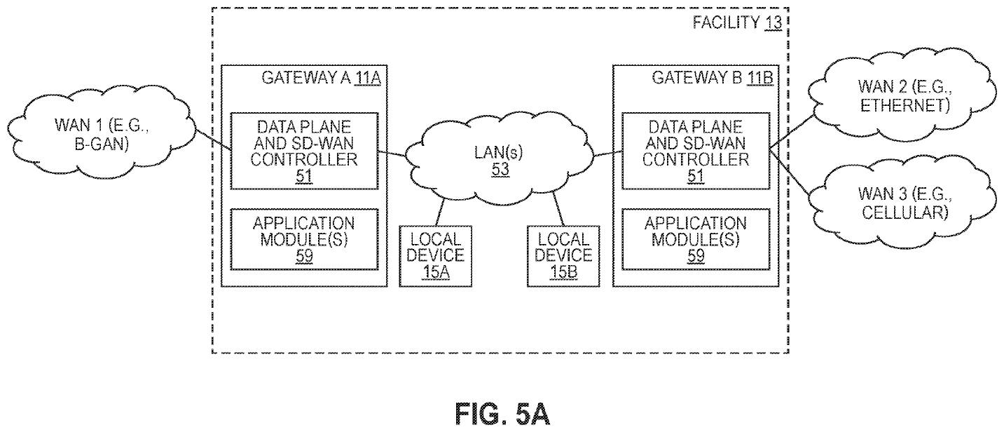

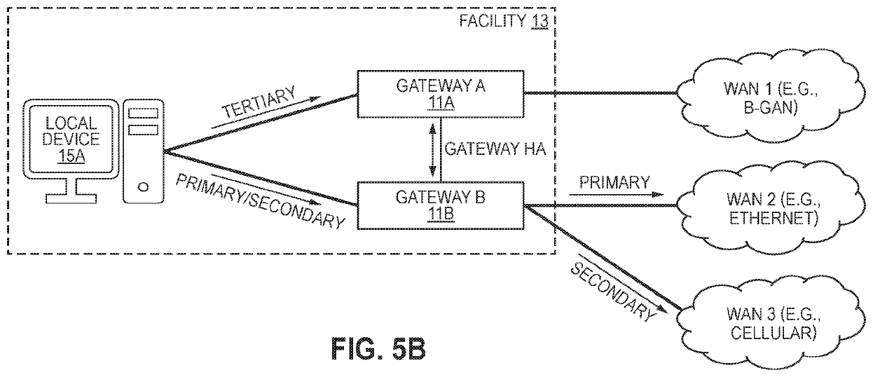

FIGS. 5A and 5B depict an example system where the SD-WAN controller and the data plane of part 51 of two gateways 11A, 11B are configured to make WAN switchover decisions based on packet loss, latency, or other network conditions of the WAN(s) of the SD-WAN implemented by the two gateways 11A, 11B. In this system, the SD-WAN controller of Gateway A (11A) configures the data plane of part 51 of Gateway A (11A) to primarily forward packet data from and to the application module(s) 59 executing on the Gateway A (11A) over the WAN 1 (B-GAN WAN) network, while the SD-WAN controller of Gateway B (111B) configures the data plane of part 51 of Gateway B (111B) to primarily forward packet data from and to the local devices (15A, 15B) connected to the LAN 53 over the WAN 2 (Ethernet WAN) network. The local devices (15A, 15B) can include edge devices, such as smart sensors, computer-based systems, industrial control systems, or other networked devices and systems. If and when the Gateway A (11A) experiences predefined network impairment conditions (e.g., loss of connectivity, packet loss, latency, or other network conditions) with regard to the primary WAN 1 (B-GAN WAN) network, the SD-WAN controller of part 51 of Gateway A (11A) automatically reconfigures the data plane of part 51 of Gateway A (11A) to forward outbound packet data to Gateway B (111B) for forwarding over the WAN 2 (Ethernet WAN) network. Return inbound packet data can be directed over the reverse path from Gateway B to Gateway A (11A). The connection between gateways A and B (11A, 111B), which is labeled Gateway HA in FIG. 5B, can be implemented directly through a cable/wireless connection or indirectly through the LAN 53 (e.g., through several switches). If and when the Gateway B (111B) experiences predefined network impairment conditions (e.g., loss of connectivity, packet loss, latency, or other network conditions) with regard to the primary WAN 2 (Ethernet WAN) network, the SD-WAN controller of part 51 of Gateway B (111B) automatically reconfigures the data plane of part 51 of Gateway B (111B) to forward outbound packet data over the secondary WAN 3 (Cellular WAN) network. If and when the Gateway B (111B) experiences predefined network impairment conditions (e.g., loss of connectivity, packet loss, latency, or other network conditions) with regard to both the primary WAN 2 (Ethernet WAN) network and the secondary WAN 3 (Cellular WAN network), the SD-WAN controller of part 51 of Gateway B (111B) can automatically reconfigure the data plane of part 51 of Gateway B (111B) to route outbound packet data to Gateway A (11A) for forwarding over the WAN 1 (B-GAN WAN) network. Return packet data can be directed over the reverse path from Gateway A (11A) to Gateway B (111B).

The SD-WAN controller and the data plane of part 51 of the two gateways 11A, 11B can also support network redundancy. For example, if and when a local device (e.g., local device 15A) on the LAN loses connectivity to the Gateway B (111B), the local device can use a LAN connection (labeled “Tertiary” in FIG. 5B) to the data plane of part 51 of Gateway A (11A), which can be configured by the SD-WAN controller of part 51 of Gateway A (11A) to forward such outbound data over the WAN 1 (B-GAN WAN) network.

The integration and functionality of the SD-WAN controller and the data plane on a gateway device as described herein allows both local devices and application modules that execute on the gateway device to automatically and seamlessly connect to the underlying WAN networks of an SD-WAN without knowing which WAN link they use in the upstream direction. Such functions can provide important benefits, including simplified management by reducing complexity and creating a simple user experience, better network visibility, reduced cost, and less vendor lock-in. It can also enrich IIoT applications with enterprise-grade network functionality. As the digital transformation matures, with more and more industrial systems connected to the cloud to generate value from data, inventory and lifecycle visibility, the network experience at the edge (e.g., facility 13), beyond just managing bandwidth becomes more important. To date, the practice of connecting field systems, which is called Industrial IoT (IIoT), typically involved gathering and relaying telemetry data from the field systems. In such HoT environments, the gateway as described herein, is configured to do far more than gathering and relaying telemetry data. Specifically, it can be configured to become the core of security, the provider of connectivity to sensors and control systems, and where data aggregation, edge computing, and intelligence is carried out.

Furthermore, the IIoT gateway as described herein can become a ‘service’ provider by extending public or corporate networks to the edge (e.g., facility 13), providing user systems or other local devices at the edge ((e.g., facility 13) with secure connectivity to both public and corporate networks. This could include linking edge capabilities with business systems or with customer networks.

Additional advantages and benefits can include: (a) providing zero-trust communication between software modules on the gateway itself, (b) providing zero-trust traffic segmentation and network connections for southbound data communication (LAN) and northbound data communication (WAN) with respect to the gateway, together with bandwidth management tools; (c) creating dynamic clusters of gateways that provide high network availability and resiliency and gateways then act like the pieces of a puzzle that can be dynamically plugged and unplugged from the network; and (d) providing a firewall-like secure isolated conduit on the gateway to receive telemetry from the local devices at the edge.

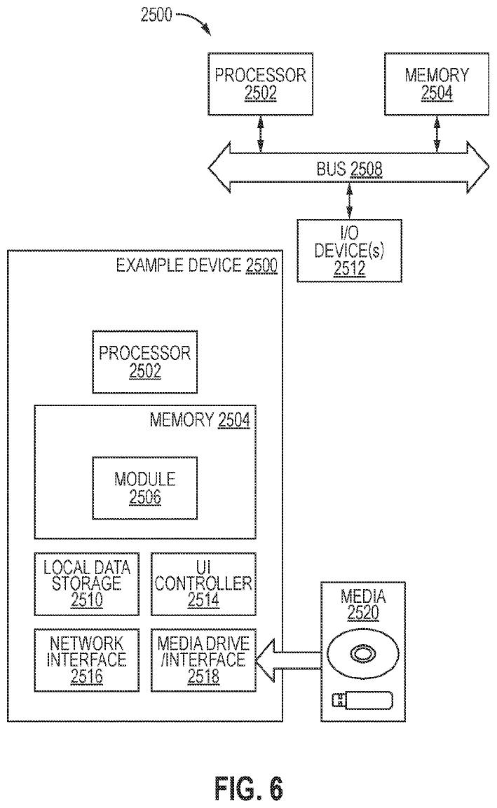

FIG. 6 illustrates an example device 2500, with a processor 2502 and memory 2504 that can be configured to implement various embodiments of the network-connected devices and systems and related methods and processes as discussed in the present application. Memory 2504 can also host one or more databases and can include one or more forms of volatile data storage media such as random-access memory (RAM), and/or one or more forms of nonvolatile storage media (such as read-only memory (ROM), flash memory, and so forth).

Device 2500 is one example of a computing device or programmable device and is not intended to suggest any limitation as to scope of use or functionality of device 2500 and/or its possible architectures. For example, device 2500 can comprise one or more computing devices, programmable logic controllers (PLCs), etc.

Further, device 2500 should not be interpreted as having any dependency relating to one or a combination of components illustrated in device 2500. For example, device 2500 may include one or more computers, such as a laptop computer, a desktop computer, a mainframe computer, etc., or any combination or accumulation thereof.

Device 2500 can also include a bus 2508 configured to allow various components and devices, such as processors 2502, memory 2504, and local data storage 2510, among other components, to communicate with each other.

Bus 2508 can include one or more of any of several types of bus structures, including a memory bus or memory controller, a peripheral bus, an accelerated graphics port, and a processor or local bus using any of a variety of bus architectures. Bus 2508 can also include wired and/or wireless buses.

Local data storage 2510 can include fixed media (e.g., RAM, ROM, a fixed hard drive, etc.) as well as removable media (e.g., a flash memory drive, a removable hard drive, optical disks, magnetic disks, and so forth). One or more input/output (I/O) device(s) 2512 may also communicate via a user interface (UI) controller 2514, which may connect with I/O device(s) 2512 either directly or through bus 2508.

In one possible implementation, a network interface 2516 may communicate outside of device 2500 via a connected network. A media drive/interface 2518 can accept removable tangible media 2520, such as flash drives, optical disks, removable hard drives, software products, etc. In one possible implementation, logic, computing instructions, and/or software programs comprising elements of module 2506 may reside on removable media 2520 readable by media drive/interface 2518.

In one possible embodiment, input/output device(s) 2512 can allow a user (such as a human annotator) to enter commands and information to device 2500, and also allow information to be presented to the user and/or other components or devices. Examples of input device(s) 2512 include, for example, sensors, a keyboard, a cursor control device (e.g., a mouse), a microphone, a scanner, and any other input devices known in the art. Examples of output devices include a display device (e.g., a monitor or projector), speakers, a printer, a network card, and so on.

Various devices and systems and processes of the present disclosure may be described herein in the general context of software or program modules, or the techniques and modules may be implemented in pure computing hardware. Software generally includes routines, programs, objects, components, data structures, and so forth that perform particular tasks or implement particular abstract data types. An implementation of these modules and techniques may be stored on or transmitted across some form of tangible computer-readable media. Computer-readable media can be any available data storage medium or media that is tangible and can be accessed by a computing device. Computer-readable media may thus comprise computer storage media. “Computer storage media” designates tangible media, and includes volatile and non-volatile, removable, and non-removable tangible media implemented for storage of information such as computer-readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage, or other magnetic storage devices, or any other tangible medium which can be used to store the desired information, and which can be accessed by a computer.

Some of the methods and processes described above can be performed by a processor. The term “processor” should not be construed to limit the embodiments disclosed herein to any particular device type or system. The processor may include a computer system. The computer system may also include a computer processor (e.g., a microprocessor, microcontroller, digital signal processor, general-purpose computer, special-purpose machine, virtual machine, software container, or appliance) for executing any of the methods and processes described above.

The computer system may further include a memory such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device.

Alternatively or additionally, the processor may include discrete electronic components coupled to a printed circuit board, integrated circuitry (e.g., Application Specific Integrated Circuits (ASIC)), and/or programmable logic devices (e.g., a Field Programmable Gate Arrays (FPGA)). Any of the methods and processes described above can be implemented using such logic devices.

Some of the methods and processes described above can be implemented as computer program logic for use with the computer processor. The computer program logic may be embodied in various forms, including a source code form or a computer-executable form. Source code may include a series of computer program instructions in a variety of programming languages (e.g., an object code, an assembly language, or a high-level language such as C, C++, or JAVA). Such computer instructions can be stored in a non-transitory computer-readable medium (e.g., memory) and executed by the computer processor. The computer instructions may be distributed in any form as a removable storage medium with accompanying printed or electronic documentation (e.g., shrink-wrapped software), preloaded with a computer system (e.g., on system ROM or fixed disk), or distributed from a server or electronic bulletin board over a communication system (e.g., the Internet or World Wide Web).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A gateway device for data communication to a corporate data network via at least one wide area network (WAN), the gateway device comprising:
at least one northbound data communication interface operably coupled to the at least one WAN;
at least one southbound data communication interface operably coupled to at least one local area network (LAN);
a data plane operably coupled to the at least one northbound data communication interface and the at least one southbound data communication interface; and
an SD-WAN controller implemented by at least one software module that executes on at least one processor of the gateway device, wherein the SD-WAN controller configures the data plane to implement at least one software-defined wide area network (SD-WAN) overlaid on the at least one WAN, and wherein the SD-WAN controller controls the data plane to intelligently forward data between the at least one LAN and the corporate data network over the at least one SD-WAN.

2. A gateway device according to claim 1, wherein:
the SD-WAN controller control the data plane to intelligently forward data generated by at least one device connected to the at least one LAN to the corporate data network over the at least one SD-WAN.

3. A gateway device according to claim 1, further comprising:
at least one application module implemented by software that executes on at least one processor of the gateway device, wherein the SD-WAN controller controls that data plane to intelligently forward application data between the application module and the corporate data network over the at least one SD-WAN.

4. A gateway device according to claim 1, wherein:
the at least one northbound data communication interface includes at least one data communication interface supporting a wired WAN connection for communication to the corporate data network.

5. A gateway device according to claim 4, wherein:
the wired WAN connection comprises an Ethernet connection.

6. A gateway device according to claim 1, wherein:
the at least one northbound data communication interface includes at least one data communication interface supporting a wireless WAN connection for communication to the corporate data network.

7. A gateway device according to claim 6, wherein:
the wireless WAN connection comprises a cellular data connection or a satellite data connection.

8. A gateway device according to claim 1, wherein:
the at least one southbound data communication interface includes at least one data communication interface supporting a wired LAN connection for communication to the at least one LAN.

9. A gateway device according to claim 8, wherein:
the wired LAN connection comprises an Ethernet connection.

10. A gateway device according to claim 1, wherein:
the at least one southbound data communication interface includes at least one data communication interface supporting a wireless LAN connection for communication to the at least one LAN.

11. A gateway device according to claim 10, wherein:
the wireless LAN connection comprises a Wi-Fi connection.

12. A gateway device according to claim 1, wherein:
the at least one software module that implements the SD-WAN controller comprises a software container.

13. A gateway device according to claim 1, wherein:
the at least one SD-WAN provides a secure connection to the corporate data network.

14. A gateway device according to claim 13, wherein:
the at least one SD-WAN further provides a secure connection to a cloud computing environment.

15. A gateway device according to claim 1, wherein:
the SD-WAN controller controls the data plane to intelligently forward outbound data to the at least one WAN of the SD-WAN according to pre-defined rules.

16. A gateway device according to claim 1, wherein:
the SD-WAN controller controls the data plane to dynamically adapt forwarding of outbound data to the at least one WAN of the SD-WAN under changing network conditions.

17. A gateway device according to claim 1, wherein:
the SD-WAN controller and the data plane cooperate to provide additional functionality selected from the group consisting of: i) network address translation or proxying services; ii) firewall services; iii) a network segmentation function that defines virtual LANs for at least one LAN; and iv) support one or more zero-trust policies, which involves authenticating and authorizing access and communication to devices and applications associated with the at least one LAN, including the at least one application module.

18. A gateway device according to claim 1, wherein:
the SD-WAN controller controls the data plane to automatically perform switchover between different WAN links of the least one SD-WAN based on network conditions related to the different WAN links.

19. A gateway device according to claim 1, wherein:
the SD-WAN controller controls the data plane to automatically perform switchover between different WAN links of SD-WANs defined by a plurality of gateway devices.

20. A gateway device according to claim 17, wherein:
the plurality of gateway devices are operably coupled to the at least one LAN or directly connected to one another.

21. A gateway device according to claim 1, wherein:
the SD-WAN controller controls the data plane to manage network redundancy for at least one local device connected to the gateway device or to manage network redundancy for at least one local device connected to a plurality of gateway devices.

22. A gateway device according to claim 1, wherein:
operations of the SD-WAN controller in configuring the data plane is programmed and controlled by a centralized controller.
